(19) United States
(12) Patent Application Publication
(10) Pub. No.: US 2026/0348834 A1
(43) Pub. Date: Nov. 5, 2026

(54) Optical Defect Inspection Based On Synthetically Generated Ellipsometric Images

(71) Applicant: KLA Corporation, Milpitas, CA (US)

(72) Inventor: Kuljit Virk, Fremont, CA (US)

(21) Appl. No.: 19/661,650

(22) Filed: Apr. 28, 2026

Related U.S. Application Data
(60) Provisional application No. 63/799,933, filed on May 5, 2025.

(51) Int. Cl. G01N 21/21; G01N 21/17; G01N 21/88

(52) U.S. Cl. CPC G01N 21/211; G01N 21/1717; G01N 21/8806; G01N 2021/1721; G01N 2021/1772; G01N 2021/8848

(57) ABSTRACT

Methods and systems for generating arbitrary synthetic ellipsometric images based on a basis set of electric fields generated by four different static optical configurations are presented herein. A patterned semiconductor specimen is inspected optically based on synthetic ellipsometric images generated from a set of basis images generated from different combinations of the basis set of electric fields. Each of the set of basis images is detected with optical components in a static optical state during a measurement interval. The set of detected images are digitally combined into a synthetic ellipsometric image based on digital values of Jones coefficients. The digital values of the Jones coefficients are optimized for a particular patterned structure under inspection to realize an ellipsometric image with high signal to noise ratio. Digital implementation of the Jones coefficients enables ellipsometry optimized for any patterned structure under inspection with high repeatability and reliability compared to optical implantations.

### CROSS REFERENCE TO RELATED APPLICATION

The present application for patent claims priority under 35 U.S.C. § 119 from U.S. provisional patent application Ser. No. 63/799,933 entitled “In-Silico Jones Matrix for Single-Shot Ellipsometric Imaging with Static Hardware Components,” filed May 5, 2025, the subject matter of which is incorporated herein by reference in its entirety.

### TECHNICAL FIELD

The described embodiments relate to optical inspection of defects in structures fabricated on semiconductor wafers and lithographic reticles.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Inspection processes are used at various steps during a semiconductor manufacturing process to detect defects on wafers to promote higher yield. As design rules and process windows continue to shrink in size, inspection systems are required to capture a wider range of physical defects on wafer surfaces while maintaining high throughput.

In general, optical wafer inspection involves collecting images of a wafer and detecting irregularities in the detected images. Typically, a semiconductor wafer includes multiple die, fabricated adjacent to one another. In a perfect manufacturing scenario, each die are identical, and thus, the wafer image should have a perfect periodic structure. Irregularities detected in the wafer image are caused by defects in the periodic structure of the wafer. These defects are targets of the wafer inspection.

The collected wafer image is affected by noise and is therefore never perfectly periodic. Some noise is introduced by imperfections of the wafer inspection tool. In addition, a significant source of measurement noise is actual wafer defects that do not have a significant impact on the functionality of the manufactured semiconductor device. These insignificant defects are commonly referred to as “nuisance” defects. Other defects do have a significant impact on the functionality of the manufactured semiconductor device. These significant defects are commonly referred to as “defects of interest” (DOI).

In practice, optical inspection is used to find small, isolated defects on lithographic reticles (photomasks) and semiconductor wafers. Typically, the wavelength of illumination light employed to image a sample is 190 nanometers, or longer. The optical diffraction limit dictates that the smallest resolvable distance between two points using a conventional microscope is never smaller than half the wavelength of the imaging light. However, in some examples, defect sizes range in size from 5 nanometers to 50 nanometers. Thus, it is not possible to optically resolve defects sized in a range from 5-50 nanometers or the underlying semiconductor device pattern because the wavelength of the imaging light is significantly larger than the underlying feature size.

Although it is not possible to resolve defects having dimensions significantly smaller than the wavelength of the imaging light, small defects are photometrically detected based on the image intensity in the vicinity of the defect. The presence of a small defect alters the image intensity in the vicinity of the defect, which is detectable in an image generated by imaging light characterized by a wavelength significantly larger than the dimensions of the defect.

The sensitivity of photometrically based detection of defects is limited by random variations in the pattern of the semiconductor device, or corresponding reticle feature employed to define the geometry of the semiconductor device. Line-edge roughness and surface roughness of semiconductor devices are on the order of 1 nanometer. Although, pattern randomness having a dimension on the order of one nanometer will not be resolved in an inspection image, pattern randomness also alters local image intensity. As such, it is critically important to be able to distinguish image intensity variations due to small defects of interest and acceptable random variations in pattern geometry.

Ellipsometric imaging has been explored as a candidate for inspection of wafer defects. Defects of interest exhibit significantly different phase retardances in diffracted fields compared to nuisance defects. Ellipsometric imaging distinguishes defects of interest from nuisance defects and wafer noise by converting phase differences into intensity differences captured by an imaging detector.

U.S. Patent Publication Nos. 2014/0204202 and 2014/0232849 by Ogawa et al., propose a dark-field imaging technique to perform image based inspection for defects sized below the resolution limit. The content of these applications is incorporated herein by reference in its entirety. In these disclosures, the illumination light is linearly polarized and an analyzer is located in the imaging path. The polarizer angle and the analyzer angle are set to minimize the image intensity in the absence of a defect, i.e., a defect free image is dark. This setting is referred to as the “null condition.” A defect is imaged as a bright spot on the dark background.

Similarly, U.S. Patent Publication Nos. 2018/0073979 and 20190113463, and “Super-contrast-enhanced darkfield imaging of nano objects through null ellipsometry,” Optics Letters, Vol. 43, Issue 23, pp. 5701-5704 (2018) by Cho et al. propose another dark-field imaging technique to perform image based inspection for defects sized below the resolution limit. The content of these references is incorporated herein by reference in its entirety. In these disclosures, the illumination light is linearly polarized and a waveplate and a polarizer are located in the imaging path. The waveplate and imaging polarizer are adjusted to achieve the “null condition.”

Although dark-field imaging at the null condition offers some advantages for imaging small defects, the ratio of defect signal to pattern noise is very low. Thus, dark-field imaging at the null condition does not offer a suitable solution for distinguishing small defects of interest from nuisance defects induced by pattern noise.

A Jones matrix mathematically describes an optical transformation physically performed on an incident electric field by one or more optical elements. When an incident electric field propagates through multiple optical elements, the optical transformation performed by the series of optical elements on the incidence electric field is described by a multiplication of the Jones matrices describing each optical element in the series. Thus, the optical transformation performed by the series of optical elements on the incidence electric field is itself described by a Jones matrix, i.e., the Jones matrix resulting from the multiplication of the Jones matrices describing each optical element in the series. The values of the coefficients of a Jones matrix associated with each optical element depend on the optical state of each optical element at each instant in time during a measurement interval.

Traditional ellipsometric imaging systems include collection optical elements that optically convert the electric field emanating from a wafer under inspection to an ellipsometric image captured at a single detector. In these systems, the Jones matrix coefficients are determined optically, i.e., the optical transformation performed by the series of collection optical elements on the electric field of the light scattered from the wafer under measurement is realized optically.

During inspection, traditional ellipsometric imaging systems are optically configured in accordance with a particular inspection recipe designed to generate images with sufficient Signal to Noise Ratio (SNR) to achieve the objectives of each particular inspection application. The inspection recipe includes a set of specific configurations of the optical elements of the imaging ellipsometer system, e.g., waveplate orientations, polarizer orientation, etc. Thus, inspection of semiconductor wafers based on ellipsometric imaging requires an inspection recipe tuned to a specific measurement application. Once the inspection recipe is determined, the ellipsometric imaging system implements the set of specific optical configurations and generates images of the wafers under inspection. In one example, the optical configuration of multiple optical elements is adjusted to achieve the “null condition” associated with a particular inspection application. Once this configuration is identified, it is implemented for in-line inspection of wafers.

Traditionally, inspection recipes are developed by collecting images at many different combinations of optical configurations to identify the set of combinations that achieves the desired SNR. This approach has several significant disadvantages. One disadvantage is that the trial and error process through the space of possible optical configurations is extremely time consuming and tedious. Optimization of the optical configuration of the inspection system for a particular defect type and wafer layer is time consuming and leads to significant downtime of inspection systems. The exploration of the space of possible optical configurations, e.g., waveplate rotations, polarizer rotations, etc., requires repeated reconfiguration of the optical settings and image detection over many hours during inspection recipe development. The speed at which optical reconfiguration occurs introduces a fundamental constraint on the time needed for inspection recipe optimization. Furthermore, the inspection system is not available for in-line inspection of production wafers during inspection recipe development. Thus, the amount of productive, operational tool utilization is reduced by the time required to perform the parameter search through the settings of the ellipsometric optical components.

Another disadvantage is that the trial and error process through the space of possible optical configurations requires a system capable of high resolution adjustment of optical configurations, e.g., wavelength retardance and polarizer angle, over the full space of possible configurations. This increases the cost and complexity of the inspection system.

Yet another disadvantage is that a system capable of high resolution adjustment of optical configurations, e.g., wavelength retardance and polarizer angle, over the full space of possible configurations is often not sufficiently repeatable. This leads to errors in the analysis of inspection images due to the uncertainty of the optical configuration during implementation of a selected inspection recipe.

In some traditional examples, phase differences are converted to optical intensity patterns using two waveplates to induce changes in retardance and a polarizer to establish a reference polarization direction in the collection path to a single detector. In many examples, changes in retardance of waveplates and changes in polarization direction of a polarizer are achieved by mechanical rotation of each optical element in a plane perpendicular to the direction of transmission of the collected beam of light. Unfortunately, mechanical rotation of optical elements is slow and not perfectly repeatable. This limits throughput, defect identification accuracy, and increases operational cost for both inspection recipe development and actual inspection. Furthermore, the mechanical assembly requires maintenance, repair, and replacement over the lifetime of the inspection system. This increases downtime and cost of ownership.

In general, the goal of wafer inspection is to capture as many defects of interest as possible and as few nuisance defects as possible. Over time, wafer inspection tools have evolved in an on-going effort to boost DOI visibility and suppress nuisance defects. However, improvements to wafer inspection systems are desired to gather additional signal information useful for improving sensitivity to DOIs, and distinguishing between DOIs and nuisance defects. Furthermore, improvements to wafer inspection systems are desired to more rapidly determine inspection recipes.

### SUMMARY

Methods and systems for generating synthetic ellipsometric images based on a basis set of electric fields generated by four different static optical configurations are presented herein. Patterned semiconductor specimens are inspected optically based on synthetic ellipsometric images generated from a set of basis images generated from different combinations of the basis set of electric fields. Each of the set of basis images is detected with optical components in a static optical state during a measurement interval. The set of detected images are digitally combined into a synthetic ellipsometric image based on digital values of Jones coefficients. The digital values of the Jones coefficients are optimized for a particular patterned structure under inspection to realize an ellipsometric image with high signal to noise ratio.

Digital implementation of the Jones coefficients enables ellipsometry optimized for any patterned structure under inspection. Furthermore, the digital implementation of the Jones coefficients enables maximum repeatability and reliability as the values of the Jones coefficients are consistently implemented with a high degree of precision compared to an optical implantation of the Jones coefficients.

In one aspect, an imaging ellipsometry system includes optical elements configured to perform multiple, different optical transformations to the electric field emanating from a specimen. The transformed electric fields comprise a basis set of transformed electric fields. In addition, the imaging ellipsometry system includes optical elements and detectors configured to generate a set of basis images indicative of the intensity of each electric field and the intensity associated with interference of each electric field with the other electric fields of the basis set.

In preferred embodiments, the optical components employed to generate the basis set of electric fields and the set of basis images are arranged in a static optical configuration. The optical components do not undergo any movement or changes of optical configuration during any particular image acquisition step of a sequence of image acquisition steps of a wafer inspection application.

In another aspect, a basis set of spatially resolved intensity images are detected including the intensity of each of the basis set of electric fields, the intensity of the interference pattern generated by the superposition of each distinct pair of the basis set of electric fields in phase, and the intensity of the interference pattern generated by the superposition of each distinct pair of the basis set of electric fields out of phase by ninety degrees.

In a further aspect, the incoherent sum of each distinct pair of basis electric fields is subtracted from the corresponding detected images of the interference pattern generated by the superposition of the corresponding pair of electric fields to generate images of the complex valued interference of each distinct pair of electric fields.

In another further aspect, a synthetic ellipsometric inspection image is generated as a linear combination of the images of the basis set of electric fields and the complex-valued images characterizing the interference of each distinct pair of the basis set of electric fields weighed by the optimized values of Jones coefficients associated with a particular inspection recipe.

In a further aspect, a set of values of Jones coefficients defining the mapping of the set of basis images to a synthetic ellipsometric inspection image for a particular inspection application is determined by an optimization of the values of the Jones coefficients over a Design Of Experiments (DOE) data set.

In a further aspect, values of the Jones coefficients are optimized for different regions of the wafer, different structures on the wafer, or both. In this manner, the values of the Jones coefficients defining the ellipsometry vary as a function of inspection location on a wafer, physical characteristics of the structure under inspection, or both. The ability to vary the value of the Jones coefficients over different regions of the wafer enables optimal signal-nuisance separation for wafers exhibiting significant within-wafer variation of film thicknesses, pattern geometry, etc.

In a further aspect, an ellipsometric imaging system also includes a computing system configured to receive a synthetic ellipsometry image, identify one or more defects of interest on the imaged specimen over the imaged area based on the intensity values of the detected image, and determine a map of defect locations.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a simplified diagram illustrative of an embodiment of an ellipsometric imaging system useful for defect inspection of semiconductor wafers and reticles.

FIG. 2 is a simplified diagram illustrative of an inspection location within the field of view of the ellipsometric imaging system depicted in FIG. 1 at an instant in time.

FIG. 3 is a simplified diagram illustrative of inspection locations associated with the fields of view of multiple sets of imaging detectors.

FIG. 4 is a diagram illustrative of a basis electric field generation module in one embodiment and a basis image generation module in one embodiment.

FIG. 5 is a diagram of an electric field transformation module in one embodiment.

FIG. 6 is a chart illustrative of optical configurations of the electric field transformation module depicted in FIG. 5.

FIG. 7 is a diagram of an electric field transformation module in another embodiment.

FIG. 8 is a chart illustrative of optical configurations of the electric field transformation module depicted in FIG. 7.

FIG. 9 is a diagram illustrative of an interferometric detection module in one embodiment.

FIG. 10 is a simplified diagram illustrative of a surface of the detector depicted in FIG. 1.

FIG. 11 is a flowchart illustrative of a method of performing defect inspection based on synthetic ellipsometric images as presented herein.

### DETAILED DESCRIPTION

Reference will now be made in detail to background examples and some embodiments of the invention, examples of which are illustrated in the accompanying drawings.

Methods and systems for generating arbitrary synthetic ellipsometric images based on a basis set of electric fields generated by four different static optical configurations are presented herein. Patterned semiconductor specimens are inspected optically based on synthetic ellipsometric images generated from a set of basis images generated from different combinations of the basis set of electric fields. Each of the set of basis images is detected with optical components in a static optical state during a measurement interval. The set of detected images are digitally combined into a synthetic ellipsometric image based on digital values of Jones coefficients. The digital values of the Jones coefficients are optimized for a particular patterned structure under inspection to realize an ellipsometric image with high signal to noise ratio.

The detection of the set of basis images with optical components in a static optical state during a measurement interval increases measurement throughput, accuracy, repeatability, and reliability compared to measurements performed with continuously moving optical elements in the imaging path. The digital implementation of the Jones coefficients enables arbitrary ellipsometry. Thus, it is possible to select an image based ellipsometry optimized for any patterned structure under inspection. Furthermore, the digital implementation of the Jones coefficients enables maximum repeatability and reliability as the values of the Jones coefficients are consistently implemented with a high degree of precision compared to an optical implantation of the Jones coefficients.

The optimization of the digital values of the Jones coefficients to achieve an ellipsometric image with high signal to noise ratio is based on a digital search through different Jones coefficient values, rather than actual optical measurements at different combinations of Jones coefficient values. This dramatically reduces the time required to determine an optimal inspection recipe with greater accuracy.

The state of fully polarized light and interactions with optical elements can be described using Jones calculus. The magnitude and phase of the electric field associated with polarized light propagating in a homogeneous, isotropic medium with negligible attenuation is represented by a Jones vector illustrated by Equation (1). E_{XX} and E_{YY} are the X and Y components of the electric field, E, respectively, where X and Y are Cartesian coordinates defining a plane perpendicular to the direction of propagation of the beam of light. Moreover, the XY coordinate frame continuously changes orientation with the wave vector of light.

$$E = ( \begin{matrix}{E}_{XX} \\ {E}_{YY}\end{matrix} ) \qquad ( 1 )$$

An optical element interacting with incident polarized light is represented by a Jones matrix. The product of the Jones matrix representing the optical element and the Jones vector representing the incident light predicts the resulting magnitude and phase of the electric field associated with light scattered from the optical element. A Jones matrix is commonly represented as a four element matrix as illustrated in Equation (2). The term, S_{XX}, is the operator associated with the transformation of the magnitude and phase of the incident electric field in the X-direction to the magnitude and phase of the scattered electric field in the X-direction. Similarly, the term, S_{YY}, is the operator associated with the transformation of the magnitude and phase of the incident electric field in the Y-direction to the magnitude and phase of the scattered electric field in the Y-direction. The terms, S_{XY} and S_{YX}, are cross-polarization terms. S_{XY} and S_{YX} are operators associated with the transformation of the magnitude and phase of the incident electric field in the X-direction to the magnitude and phase of the scattered electric field in the Y-direction, and vice-versa.

$$S = ( \begin{matrix}{S}_{XX} & {S}_{XY} \\ {S}_{YX} & {S}_{YY}\end{matrix} ) \qquad ( 2 )$$

For purposes of reticle and wafer inspection, a defect of interest and nuisance pattern noise structures can each be represented by a different scattering matrix. The differences in properties of these scattering matrices offer clues as to how light scattered from a defect of interest can be distinguished from light scattered from nuisance pattern noise structures. The images generated by the proposed ellipsometric imaging techniques described herein provide intensity contrast that is indicative of phase differences induced by the scattering response of different structures in the imaging field of the ellipsometric imaging system. Moreover, these phase differences allow differentiation of defects of interest from nuisance pattern noise with relatively high signal to noise ratio.

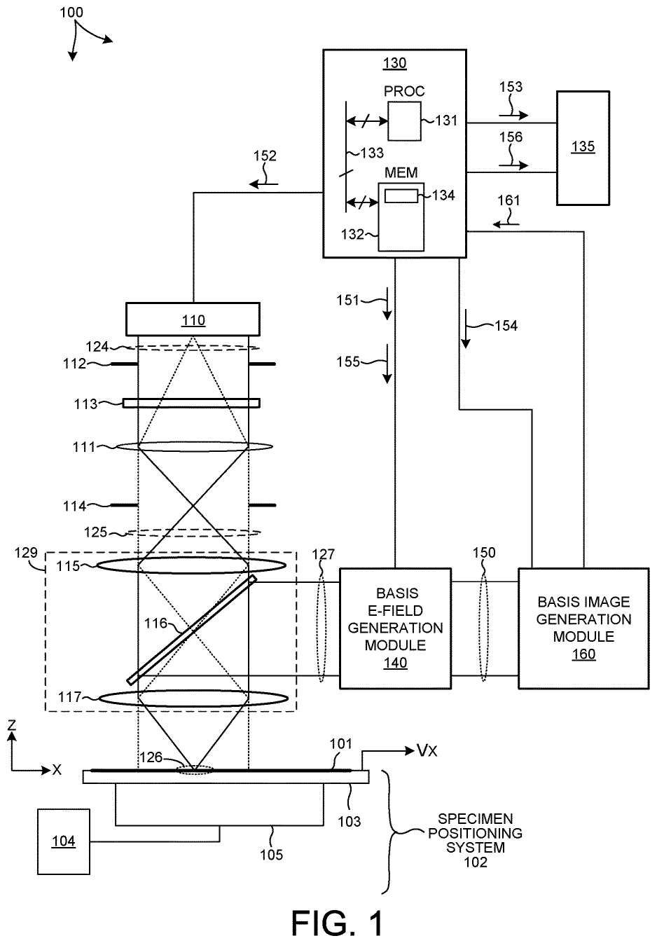

FIG. 1 is a simplified diagram illustrative of an embodiment of an ellipsometric imaging system 100 useful for defect inspection of semiconductor wafers and reticles. Ellipsometric imaging system 100 includes a basis electric field generation module 140 that performs four different optical transformations to the electric field emanating from a wafer under inspection. The resulting transformed electric fields comprise a basis set of electric fields. Ellipsometric imaging system 100 includes a basis image generation module 160 that generates a set of basis images indicative of the intensity of each electric field and the intensity associated with interference of each electric field with the other electric fields of the set of basis electric fields.

For simplification, some optical components of the system have been omitted. By way of example, folding mirrors, polarizers, beam forming optics, additional light sources, additional collectors, and detectors may also be included. All such variations are within the scope of the invention described herein. The inspection system described herein may be used for inspecting patterned wafers and reticles.

As illustrated in FIG. 1, ellipsometric imaging system 100 includes an illumination source 110. Illumination source 110 may include, by way of example, a laser driven plasma light source, a laser, a diode laser, a helium neon laser, an argon laser, a solid state laser, a diode pumped solid state (DPSS) laser, a xenon arc lamp, a gas discharging lamp, an LED array, or an incandescent lamp. The light source may be configured to emit near monochromatic light or broadband light. In a preferred embodiment, illumination source 110 is a monochromatic laser light source. In some embodiments, a monochromatic, laser light source emits light having a peak wavelength of 157, 193, or 266 nanometers. These wavelengths are well suited for high resolution inspection of features at the surface of a specimen with minimal penetration below the surface. In some other embodiments it is desirable to perform inspection of features below the surface of the specimen. In these embodiments, a longer wavelength, monochrome light source, e.g., a wavelength in the visible to infrared range of wavelengths, is preferred. In some embodiments, illumination source 110 includes a combination of multiple light sources. In some embodiments, illumination source 110 includes one or more spatially and temporally coherent, high-brightness illumination sources, e.g., one or more high power laser based illumination sources. A coherent, high-brightness illumination source enables high spectral intensity, and thus good signal to noise ratio.

As depicted in FIG. 1, ellipsometric imaging system 100 includes an illumination subsystem configured to direct illumination light 124 through the illumination subsystem. The resulting polarized illumination light 125 propagates through objective 129 onto inspection location 126 on the surface of specimen 101.

As depicted in FIG. 1, the illumination subsystem includes illumination source 110, pupil stop 112, polarizing component 113, beam shaping optics 111, and field stop 114. As depicted, in FIG. 1, the beam of illumination light 124 is focused by beam shaping optics 111. The focused light passes through pupil stop 112, polarizing component 113, and illumination field stop 114 as the beam propagates from the illumination source 110 to objective 129.

In the embodiment depicted in FIG. 1, pupil stop 114 controls the numerical aperture of the illumination at the wafer (NA_{ILL}) and may include any suitable commercially available aperture stop. The illumination field stop controls the field of view (FOV) of the illumination subsystem and may include any suitable commercially available field stop.

In general, the illumination subsystem may include any type and arrangement of optical filter(s), polarizing component, field stop, pupil stop, etc., known in the art of ellipsometry. In addition, the illumination subsystem may include filters, masks, apodizers, etc. For example, the illumination subsystem may include one or more optical filters (not shown). The optical filters are employed to control light level, spectral output, or both, from the illumination subsystem. In some examples, one or more multi-zone filters are employed as optical filters. In some embodiments, beam shaping optics 111 include one or more optical elements having reflective focusing power.

In some examples, noise and polarization optimization are performed to improve the performance of illumination source 110. In some examples, depolarization is achieved by use of multimode fibers, a Hanle depolarizer, or an integration sphere. In some examples, the illumination source etendue is optimized by use of light guides, fibers, and other optical elements (e.g., lenses, curved mirrors, apodizers, etc.).

Polarizing component 113 generates the desired polarization state exiting the illumination subsystem. In some embodiments, the polarizing component includes a polarizer, a compensator, or both, and may include any suitable commercially available polarizing component. The polarizer, compensator, or both, can be fixed, or rotatable to different fixed positions. Although the illumination subsystem depicted in FIG. 1 includes one polarizing component, the illumination subsystem may include more than one polarizing component. In some embodiments, a polarizer of polarizing component 113 is a Magnesium Fluoride Rochon polarizer. In some embodiments, a compensator of polarizing component 113 includes a quartz waveplate, a Magnesium Fluoride waveplate, a Calcium Fluoride K-prism, a Calcium Fluoride double Fresnel rhomb, or any combination thereof. In some embodiments, a compensator of polarizing component 113 includes one or more waveplates.

In a preferred embodiment, polarizing component 113 is rotatable, and is adjusted to provide linear polarization at 45 degrees. In this manner, illumination light includes both x and y components in equal measure.

As depicted in FIG. 1, objective 129 includes lenses 115 and 117, and beam splitting element 116. In some embodiments, the elements of objective 129 are integrated into a single opto-mechanical package. Objective 129 focuses illumination beam 125 onto inspection location 126.

Ellipsometric imaging system 100 also includes a collection optics subsystem configured to collect light generated by the interaction between the one or more structures under inspection and the incident illumination beam 125.

As depicted in FIG. 1, objective 129 collects light from inspection location 126 in response to the incident illumination light and directs the collected electric field 127 toward basis electric field generation module 140 and basis image generation module 160.

As depicted in FIG. 1, ellipsometric imaging system 100 includes a specimen positioning system 102 that moves specimen 101 within the field of view of the imaging detectors of basis image generation module 160. In some embodiments, specimen positioning system 102 moves specimen 101 in a scanning motion in the X-direction. In this manner, the field of view of the imaging detectors of basis image generation module 160 moves across the specimen in the X-direction.

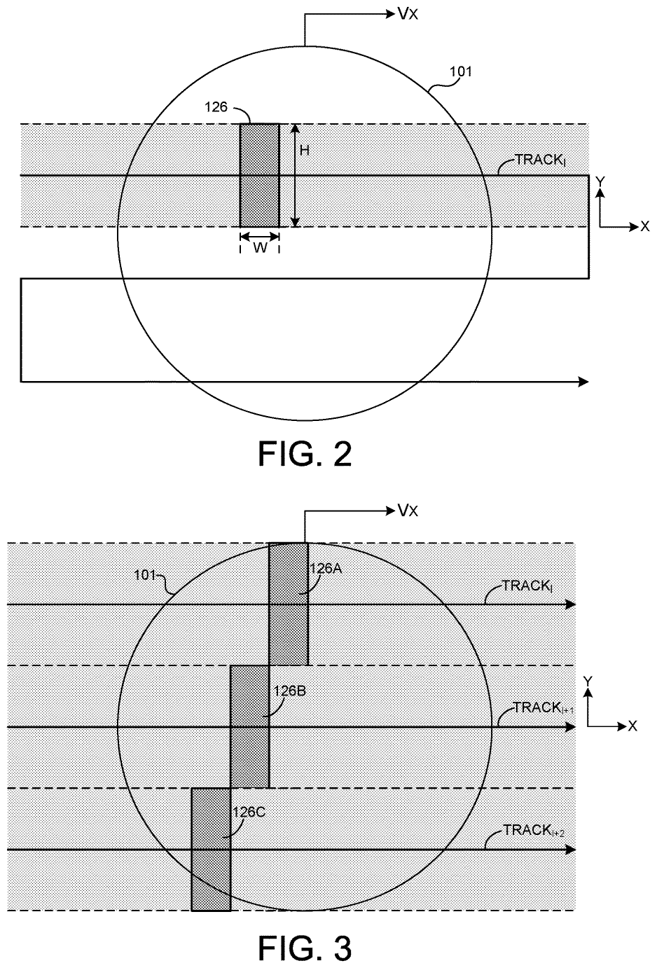

In an exemplary operational scenario, inspection begins with specimen 101 entering the field of view of the imaging detectors of basis image generation module 160. Due to the translation of specimen 101 in the X-direction by specimen positioning system 102, the locus of inspection locations detected within the field of view of the imaging detectors of basis image generation module 160 traces a swath across the surface of specimen 101 in the X-direction. The swath on the surface of specimen 101 is referred to as an inspection track. FIG. 2 depicts an inspection location within the field of view of the imaging detectors of basis image generation module 160 at an instant in time. Inspection track, Trackᵢ, illustrates the swath of imaged area across the surface of specimen 101 due to a single scan in the X-direction. In some embodiments, specimen positioning system 101 repeatedly translates specimen 101 in the Y-direction, and scans specimen 101 in the X direction to inspect the entire area of specimen 101.

In general, specimen 101 may be moved across the fields of view the imaging detectors of basis image generation module 160 in many other operational modes. In some embodiments, specimen positioning system 102 is a rotational stage system that rotates specimen 101 about a center of rotation and translates the center of rotation such that the inspection track is a spiral pattern. In some embodiments, specimen 101 is moved in a stepwise fashion. In these embodiments, specimen 101 is moved to a position, measured, moved to another position, measured, in a repeated manner until the area of specimen 101 is imaged by the imaging detectors of basis image generation module 160.

In some embodiments, additional sets of imaging detectors are employed to improve throughput. For example, FIG. 3 illustrates inspection locations 126A-C associated with the fields of view of three different sets of the imaging detectors of basis image generation module 160. The locus of inspection locations detected within the field of view of one set of imaging detectors traces a swath associated with Trackᵢ. The locus of inspection locations detected within the field of view of another set of imaging detectors traces a swath associated with Trackᵢ₊₁. The locus of inspection locations detected within the field of view of yet another imaging detector traces a swath associated with Trackᵢ₊₂. All three sets of imaging detectors collect image data simultaneously as specimen 101 is translated in the X-direction by specimen positioning system 102. In the embodiment depicted in FIG. 3, specimen positioning system 101 scans specimen 101 in the X direction one time to inspect the entire area of specimen 101.

In the embodiments described with reference to FIG. 2 and FIG. 3, a measured area of specimen 101 is moved across the field of view of a set of imaging detectors. In general, however, a measured area of specimen 101 may be moved across the field of view of any number of different sets of imaging detectors to image a measured area of specimen 101. In some embodiments, a multiple zone imaging detector device includes multiple, small imaging detector zones (e.g., single pixel column resolution) that generate a large number of images of each measured location on specimen 101. In one embodiment, a two dimensional CMOS detector is subdivided into multiple, small imaging detector zones. Since each pixel of a CMOS detector is independently addressable, images are collected independently by separate detector electronics associated with each of the imaging detector zones.

In some embodiments, ellipsometric imaging system 100 may include a deflector (not shown) that scans an illumination beam over the surface of specimen 101 instead of, or in addition to, the movement of specimen 101 by specimen positioning system 102. In one embodiment, the deflector may be an acousto-optical deflector (AOD). In other embodiments, the deflector may include a mechanical scanning assembly, an electronic scanner, a rotating mirror, a polygon based scanner, a resonant scanner, a piezoelectric scanner, a galvo mirror, or a galvanometer. The deflector scans the light beam over the specimen. In some embodiments, the deflector may scan the light beam over the specimen at an approximately constant scanning speed.

As depicted in FIG. 2, the measurement area 126 within the field of view of the imaging detectors of basis image generation module 160 is characterized by a height, H, and a width, W. In general, H and W may be any suitable dimensions. In some examples, H extends over a relatively large number of image pixels and W is the width of a single pixel. In other examples, W is the width of multiple pixels, and the imaging detectors of basis image generation module 160 collect light over a two dimensional array of pixels. In some examples, H, may extend all the way across specimen 101 (e.g., at least 300 millimeters). In some examples, W, may also extend all the way across specimen 101 (e.g., at least 300 millimeters).

In some embodiments, the imaging detectors of basis image generation module 160 are charge-coupled device (CCD) detectors. In some embodiments, the imaging detectors of basis image generation module 160 are complementary metal on silicon (CMOS) detectors. In some examples, CMOS detectors include the capability to perform arithmetic operations on detected optical intensities in real time at the detector before communication to a computing system. In some examples, a CMOS detector performs an arithmetic operation to subtract the incoherent component of a detected interference pattern as described hereinafter.

In some embodiments, the imaging detectors of basis image generation module 160 are integrated into a multiple zone detector device. In some other embodiments, multiple imaging detectors are each stand-alone devices.

In preferred embodiments, the imaging detectors of basis image generation module 160 operate in a time delay integration (TDI) mode to maximize light collection and increase signal to noise ratio. In these embodiments, each measurement location is measured by each detector pixel across the width dimension, W, and the measured signals associated with each measurement location are summed to arrive at the image signal associated with each particular measurement location.

In some embodiments, the imaging detectors of basis image generation module 160 operate in a step and flash mode or scan and flash mode. In some embodiments, the imaging detectors of basis image generation module 160 operate in a line scanning mode (e.g., field of view having a width of one pixel scanned across the specimen).

In one aspect, an imaging ellipsometry system includes optical elements configured to perform multiple, different optical transformations to the electric field 127 emanating from wafer 101. The transformed electric fields 150 comprise a basis set of electric fields. In addition, the imaging ellipsometry system includes optical elements and detectors configured to generate a set of basis images 161 indicative of the intensity of each electric field and the intensity associated with interference of each electric field with the other electric fields of the set of basis electric fields.

In preferred embodiments, the optical components employed to generate the basis set of electric fields and the set of basis images are arranged in a static optical configuration. In some embodiments, the optical components do not undergo any movement or changes of optical configuration during any particular image acquisition step of a sequence of image acquisition steps of a wafer inspection application. In some other embodiments, the optical components do not undergo any movement or changes of optical configuration during all image acquisition steps of a sequence of image acquisition steps of a wafer inspection application.

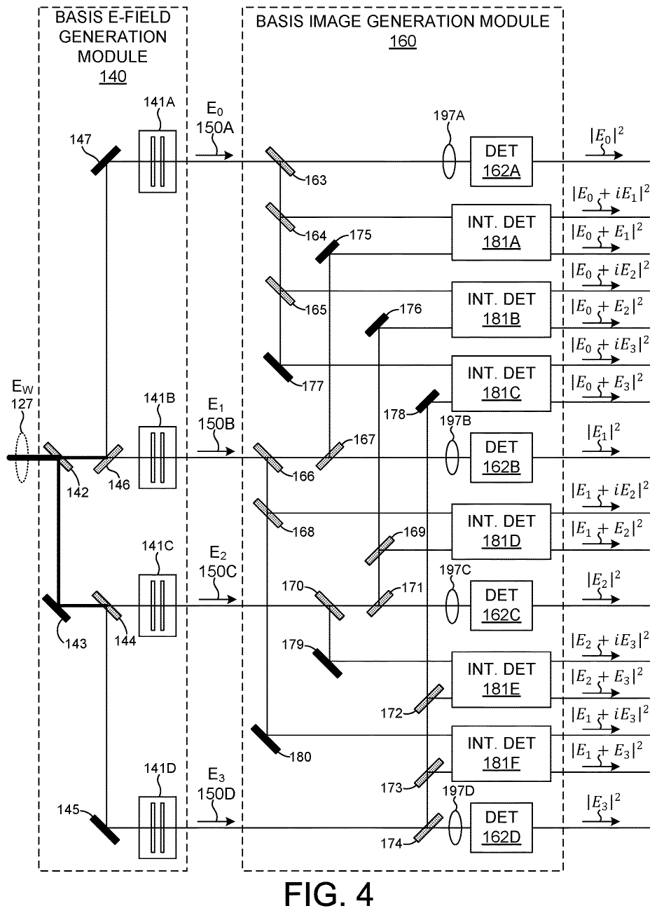

In some embodiments, a basis set of four different static optical configurations are implemented by an imaging ellipsometry system. As depicted in FIGS. 1 and 4, four different static optical transformations of the electric field emanating from a wafer 101 under inspection, E_{w} 127, are implemented optically at a pupil plane of the ellipsometric imaging system by four different instances of an optical transformation module each implemented in a different optical configuration. The four different static optical configurations are designed as a basis set such that any possible optical configuration of the optical components of the ellipsometer can be generated as a linear combination of the basis set of four different static optical configurations. Thus, the basis set of four different static optical configurations generate the fundamental electric field components of a generalized ellipsometric imaging system.

FIG. 4 is a diagram illustrative of a basis electric field generation module 140 in one embodiment and a basis image generation module 160 in one embodiment.

As depicted in FIG. 4, the electric field, E_{w} 127, collected from wafer 101 is subdivided into four spatially distinct channels by the illustrated arrangement of beam splitting elements 142, 144, and 146, and reflective elements 143, 145, and 147. The particular configuration of beam splitting elements 142, 144, and 146, and reflective elements 143, 145, and 147 are provided by way of non-limiting example. In general, any combination of optical elements configured to subdivide the electric field, E_{w} 127, collected from wafer 101 into four spatially distinct channels is contemplated within the scope of this patent document.

Each of the spatially distinct portions of electric field, E_{w} 127, is directed to a corresponding optical transformation module, 141A-D, located in the optical path of each spatially distinct portion of electric field, E_{w} 127. Each instance of the optical transformation module, 141A-D, is optically configured to perform a different optical transformation on E_{w} 127. The basis set of electric fields generated by each instance of basis electric field generation modules 141A-D are labeled E. 150A, E₁ 150B, E₂ 150C, and E₃ 150D, respectively.

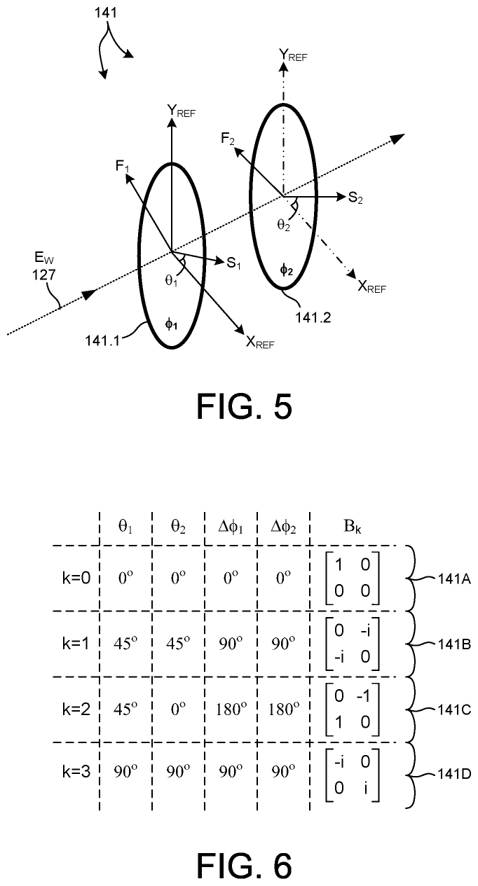

FIG. 5 is a diagram of an electric field transformation module 141 in one embodiment. As depicted in FIG. 5, electric field transformation module 141 includes two waveplates. Waveplate 141.1 is characterized by a fast axis, F₁, and a slow axis, S₁, perpendicular to the fast axis. The fast and slow axes form a plane perpendicular to the direction of propagation of incident electric field, e.g., E_{w} 127. Waveplate 141.1 is characterized by a retardance, φ₁, and a clocking angle, θ₁. A clocking angle describes the orientation of a waveplate about an axis aligned with the direction of propagation of the electric field passing through the waveplate with respect to a fixed reference frame. In the embodiment depicted in FIG. 5, the clocking angle, θ₁, is defined as the angle between the slow axis, S₁, and the x-axis of a fixed reference frame, {Xref, Yref}. The reference frame is fixed with respect to the ellipsometry imaging system 100.

Similarly, waveplate 141.2 is characterized by a fast axis, F₂, and a slow axis, S₂, perpendicular to the fast axis. Waveplate 141.2 is characterized by a retardance, φ₂, and a clocking angle, θ₂. In the embodiment depicted in FIG. 5, the clocking angle, θ₂, is defined as the angle between the slow axis, S₂, and the x-axis of fixed reference frame, {Xref, Yref}.

FIG. 6 is a chart illustrative of the optical configurations of each of the instances 141A-D depicted in FIG. 1 of the electric field transformation module 141 depicted in FIG. 5. FIG. 6 illustrates four different optical configurations of electric field transformation module 141, k={0, 1, 2, 3}.

As depicted in FIG. 6, electric field transformation module 141A is configured with a first waveplate having a retardance, φ₁=0, and a clocking angle, θ₁=0, and a second waveplate having a retardance, φ₂=0, and a clocking angle, θ₂=0. In some embodiments, electric field transformation module 141A includes no optical elements to realize the optical configuration associated with k=0. B₀ is the Jones matrix describing the optical transformation performed by electric field transformation module 141A configured in accordance with configuration k=0.

Electric field transformation module 141B is configured with a first waveplate having a retardance, φ₁=90 degrees, and a clocking angle, θ₁=45 degrees, and a second waveplate having a retardance, φ₂=90 degrees, and a clocking angle, θ₂₌₄₅ degrees. In some embodiments, electric field transformation module 141B includes two quarter waveplates. B₁ is the Jones matrix describing the optical transformation performed by electric field transformation module 141B configured in accordance with configuration k=1.

Electric field transformation module 141C is configured with a first waveplate having a retardance, φ₁=180 degrees, and a clocking angle, θ₁=45 degrees, and a second waveplate having a retardance, φ₂=180 degrees, and a clocking angle, θ₂₌₀ degrees. In some embodiments, electric field transformation module 141C includes two half waveplates. B₂ is the Jones matrix describing the optical transformation performed by electric field transformation module 141C configured in accordance with configuration k=2.

Electric field transformation module 141D is configured with a first waveplate having a retardance, φ₁=90 degrees, and a clocking angle, θ₁=90 degrees, and a second waveplate having a retardance, φ₂=90 degrees, and a clocking angle, θ₂₌₉₀ degrees. In some embodiments, electric field transformation module 141D includes two quarter waveplates. B₃ is the Jones matrix describing the optical transformation performed by electric field transformation module 141D configured in accordance with configuration k=3.

Each different transformation of the basis set of optical transformations can be modeled by a Jones Matrix representing a generic unitary transformation of the electric field in the pupil plane. In the example set of configurations depicted in FIG. 6, the set of Jones matrices, B₀, B₁, B₂, and B₃, are the Pauli matrices.

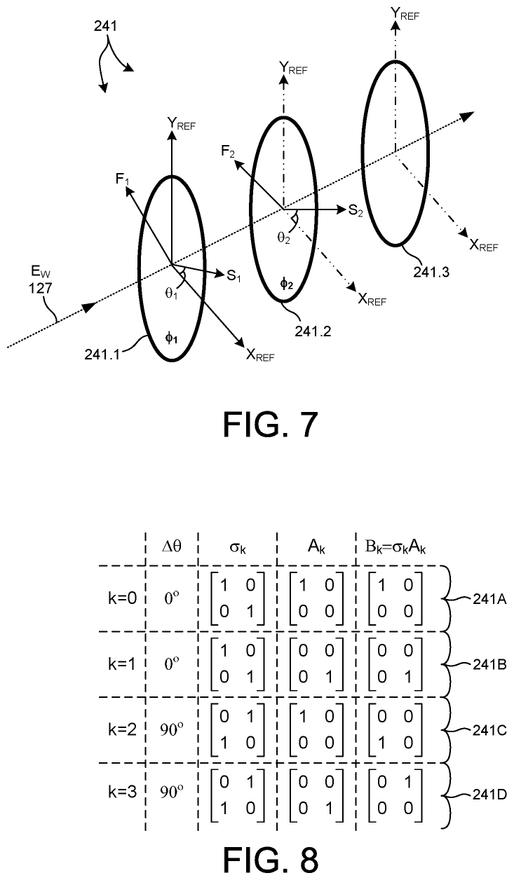

FIG. 7 is a diagram of an electric field transformation module 241 in one embodiment. In another embodiment of basis electric field generation module 140 depicted in FIG. 4, the instances of electric field transformation modules 141A-D are replaced by instances of electric field transformation module 241A-D.

As depicted in FIG. 7, the electric field transformation module 241 includes two waveplates, and a polarizer. Waveplate 241.1 is characterized by a fast axis, F₁, and a slow axis, S₁, perpendicular to the fast axis. The fast and slow axes form a plane perpendicular to the direction of propagation of incident electric field, e.g., E_{w} 127. Waveplate 241.1 is a quarter waveplate characterized by retardance, φ₁=90 degrees, and clocking angle, θ₁. Similarly, waveplate 241.2 is a quarter waveplate characterized by a fast axis, F₂, and a slow axis, S₂, perpendicular to the fast axis. Waveplate 241.2 is characterized by a retardance, φ₂=45 degrees, and a clocking angle, θ₂. Polarizer 241.3 is located after waveplates 241.1 and 241.2 along the direction of propagation of the incident electric field, E_{w} 127.

FIG. 8 is a chart illustrative of the optical configurations of each of the instances 241A-D of the electric field transformation module 241 depicted in FIG. 7. FIG. 8 illustrates four different optical configurations of electric field transformation module 241, k={0, 1, 2, 3}, corresponding to the instances of electric field transformation module 241A-D.

As depicted in FIG. 8, electric field transformation module 241A is configured with a difference in clocking angle, Δθ=0, between the clocking angle of waveplate 241.2 and the clocking angle of waveplate 241.1, i.e., Δθ=θ₂−θ₁=0. Polarizer 241.3 is configured as a linear polarizer with a reference direction aligned with the x-direction, X_{ref}, of the {X_{ref}, Y_{ref}} reference frame. In some embodiments, electric field transformation module 241A includes no waveplates. In some other embodiments, electric field transformation module 241A includes two quarter waveplates. Go is the Jones matrix describing the optical transformation performed by the combination of waveplates 241.1 and 241.2 configured in accordance with configuration k=0. A₀ is the Jones matrix describing the optical transformation performed by polarizer 241.3 configured in accordance with configuration k=0. B₀ is the Jones matrix describing the optical transformation performed by electric field transformation module 241A configured in accordance with configuration k=0.

As depicted in FIG. 8, electric field transformation module 241B is configured with a difference in clocking angle, Δθ=0, between the clocking angle of waveplate 241.2 and the clocking angle of waveplate 241.1. Polarizer 241.3 is configured as a linear polarizer with a reference direction aligned with the y-direction, Y_{ref}, of the {X_{ref}, Y_{ref}} reference frame. In some embodiments, electric field transformation module 241B includes no waveplates. In some other embodiments, electric field transformation module 241B includes two quarter waveplates. σ₁ is the Jones matrix describing the optical transformation performed by the combination of waveplates 241.1 and 241.2 configured in accordance with configuration k=1. A₁ is the Jones matrix describing the optical transformation performed by the polarizer 241.3 configured in accordance with configuration k=1. B₁ is the Jones matrix describing the optical transformation performed by electric field transformation module 241B configured in accordance with configuration k=1.

As depicted in FIG. 8, electric field transformation module 241C is configured with a difference in clocking angle, Δθ=90 degrees, between the clocking angle of waveplate 241.2 and the clocking angle of waveplate 241.1. Polarizer 241.3 is configured as a linear polarizer with a reference direction aligned with the x-direction, X_{ref}, of the {X_{ref}, Y_{ref}} reference frame. In some embodiments, electric field transformation module 241C includes two quarter waveplates. σ2 is the Jones matrix describing the optical transformation performed by the combination of waveplates 241.1 and 241.2 configured in accordance with configuration k=2. A₂ is the Jones matrix describing the optical transformation performed by the polarizer 241.3 configured in accordance with configuration k=2. B₂ is the Jones matrix describing the optical transformation performed by electric field transformation module 241C configured in accordance with configuration k=2.

As depicted in FIG. 8, electric field transformation module 241D is configured with a difference in clocking angle, Δθ=90 degrees, between the clocking angle of waveplate 241.2 and the clocking angle of waveplate 241.1. Polarizer 241.3 is configured as a linear polarizer with a reference direction aligned with the y-direction, X_{ref}, of the {X_{ref}, Y_{ref}} reference frame. In some embodiments, electric field transformation module 241D includes two quarter waveplates. σ₃ is the Jones matrix describing the optical transformation performed by the combination of waveplates 241.1 and 241.2 configured in accordance with configuration k=3. A₃ is the Jones matrix describing the optical transformation performed by the polarizer 241.3 configured in accordance with configuration k=3. B₀ is the Jones matrix describing the optical transformation performed by electric field transformation module 241D configured in accordance with configuration k=3.

Each different transformation of the basis set of optical transformations can be modeled by a Jones Matrix representing a generic unitary transformation of the electric field in the pupil plane. The set of matrices, B₀, B₁, B₂, and B₃, depicted in FIG. 8 are the Jones matrices associated with the optical configurations of electric field transformation module 241 depicted in FIG. 7. Thus the set of optical transformations describing the optical transformation performed by the instances 241A-D of the electric field transformation modules 241 are the set of Jones matrices {B₀, B₁, B₂, B₃} depicted in FIG. 8.

The optical components of the basis electric field generation module 140 and the basis image generation module 160 transform the electric field of each imaging channel uniformly across pupil coordinates. The resulting electric field of each imaging channel is focused by focusing optics onto the photosensitive surface of a spatially resolved detector.

In another aspect, a basis set of spatially resolved intensity images are detected including the intensity of each of the basis set of electric fields, the intensity of the interference pattern of the superposition of each distinct pair of the basis set of electric fields in phase, and the intensity of the interference pattern of the superposition of each distinct pair of the basis set of electric fields out of phase by ninety degrees.

Basis image generation module 160 depicted in FIG. 4 also includes multiple detectors configured to detect the intensity of each basis electric field, E. 150A, E₁ 150B, E₂ 150C, and E₃ 150D. Furthermore, basis image generation module 160 depicted in FIG. 4 includes multiple interferometric detection modules configured to generate and detect the intensity of the interference pattern generated by the superposition of each distinct pair of the basis set of electric fields in phase, and generate and detect the intensity of the interference pattern generated by the superposition of each distinct pair of the basis set of electric fields out of phase by ninety degrees.

As depicted in FIG. 4, the basis set of electric fields {E₀, E₁, E₂, E₃} generated by basis electric field generation module 140 propagate to basis image generation module 160. As depicted in FIG. 4, each basis electric field is subdivided into four spatially distinct optical paths by the illustrated arrangement of beam splitting elements 163-174 and reflective elements 175-180. In addition, the illustrated arrangement of beam splitting elements 163-174 and reflective elements 175-180 directs one portion of each of the basis set of electric fields {E₀, E₁, E₂, E₃} to a corresponding imaging detector. Each imaging detector generates a spatially resolved image of the intensity of each of the basis set of electric fields {E₀, E₁, E₂, E₃}.

As illustrated in FIG. 4, basis electric field E₀ 150A is focused onto the active surface of imaging detector 162A by focusing optical element 197A. Imaging detector 162A generates an image of the intensity of the basis electric field, |E₀|². Similarly, basis electric field E₁ 150B is focused onto the active surface of imaging detector 162B by focusing optical element 197B. Imaging detector 162B generates an image of the intensity of the basis electric field, |E|². Basis electric field E₂ 150C is focused onto the active surface of imaging detector 162C by focusing optical element 197C. Imaging detector 162C generates an image of the intensity of the basis electric field, |E₂|². Basis electric field E₃ 150D is focused onto the active surface of imaging detector 162D by focusing optical element 197D. Imaging detector 162D generates an image of the intensity of the basis electric field, |E₃|².

Basis electric fields E₀ 150A and E₁ 150B are directed to an instance 181A of an interferometric detector module. The interferometric detector module superimposes basis electric fields E₀ and E₁ in phase and detects a spatially resolved image of the resulting interference pattern, |E₀+E₁|². In addition, the interferometric detector module superimposes basis electric fields E₀ and E₁ out of phase by ninety degrees and detects a spatially resolved image of the resulting interference pattern, |E₀+iE₁|².

Similarly, as depicted in FIG. 4, each distinct pair-wise combination of the set of basis electric fields {E₀, E₁, E₂, E₃}, is directed to a different instance of an interferometric detector, i.e., {E₀, E₂} is directed to instance 181B, {E₀, E₃} is directed to instance 181C, {E₁, E₂} is directed to instance 181D, {E₂, E₃} is directed to instance 181E, and {E₁, E₃} is directed to instance 181F.

Each instance of an interferometric detector module superimposes the incident electric fields in phase and detects a spatially resolved image of the resulting interference pattern and superimposes the incident basis electric fields out of phase by ninety degrees and detects a spatially resolved image of the resulting interference pattern. As depicted in FIG. 4, instance 181B superimposes {E₀, E₂} in phase and detects a spatially resolved image of the resulting interference pattern, |E₀+E₂|², and superimposes {E₀, E₂} out of phase by ninety degrees and detects a spatially resolved image of the resulting interference pattern, |E₀+iE₂|². Instance 181C superimposes {E₀, E₃} in phase and detects a spatially resolved image of the resulting interference pattern, |E₀+E₃|², and superimposes {E₀, E₃} out of phase by ninety degrees and detects a spatially resolved image of the resulting interference pattern, |E₀+iE₃|². Instance 181D superimposes {E₁, E₂} in phase and detects a spatially resolved image of the resulting interference pattern, |E₁+E₂|², and superimposes {E₁, E₂} out of phase by ninety degrees and detects a spatially resolved image of the resulting interference pattern, |E₁+iE₂|². Instance 181E superimposes {E₂, E₃} in phase and detects a spatially resolved image of the resulting interference pattern, |E₂+E₃|², and superimposes {E₂, E₃} out of phase by ninety degrees and detects a spatially resolved image of the resulting interference pattern, |E₂+iE₃|². Instance 181F superimposes {E₁, E₃} in phase and detects a spatially resolved image of the resulting interference pattern, |E₁+E₃|², and superimposes {E₁, E₃} out of phase by ninety degrees and detects a spatially resolved image of the resulting interference pattern, |E₁+iE₃|².

The particular configuration of beam splitting elements 163-174, and reflective elements 175-180 are provided by way of non-limiting example. In general, any combination of optical elements configured to subdivide each basis electric field into four spatially distinct optical paths is contemplated within the scope of this patent document.

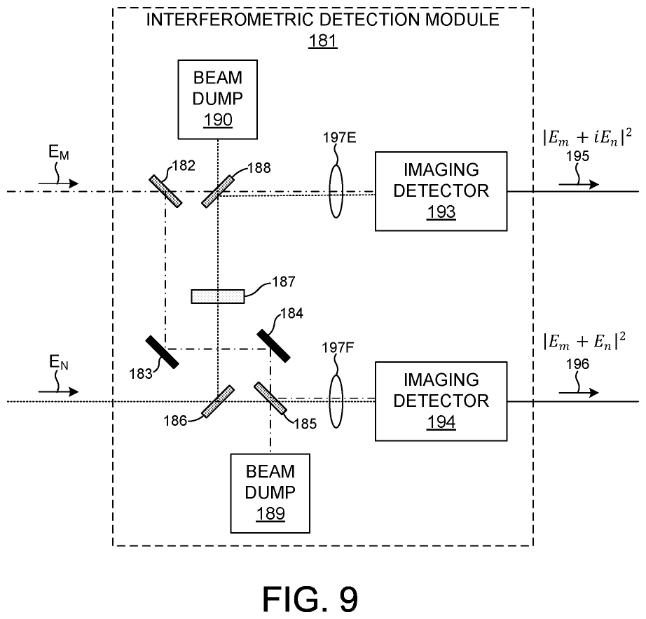

FIG. 9 is a diagram illustrative of an interferometric detection module 181 in one embodiment. As depicted in FIG. 9, interferometric detection module 181 is configured to superimpose one electric field with another electric field, both in phase and out of phase by ninety degrees, and detect a spatially resolved image of each interference pattern.

In some embodiments, instances 181A-F of an interferometric detector module depicted in FIG. 4 are instances of interferometric detector module 181 depicted in FIG. 9. As depicted in FIG. 9, a distinct pair, {Eₘ, Eₙ}, of the basis set of electric fields {E₀, E₁, E₂, E₃} are provided to interferometric detector module 181. A distinct pair includes any pair-wise combination of different electric fields selected of the basis set of electric fields. As depicted in FIG. 9, a basis electric field, Eₘ, selected from the basis set of electric fields is subdivided and directed to both imaging detectors 193 and 194 in accordance with the arrangement of beam splitting elements 182 and 185 and reflective elements 183 and 184. Similarly, a different basis electric field, Eₙ, where m≠n, selected from the basis set of electric fields is subdivided and directed to both imaging detectors 193 and 194 in accordance with the arrangement of beam splitting elements 186 and 188.

Beam splitter 185 effectively superimposes a portion of basis electric field, Eₘ, with a portion of basis electric field Eₙ. The portion of the electric field, Eₘ, transmitted through beam splitter 185 propagates to beam dump 189. The portion of the electric field, Eₘ, reflected from beam splitter 185 is superimposed with a portion of electric field, Eₙ. The superimposed electric field includes electric field, Eₘ, superimposed with electric field, Eₙ, in phase. Furthermore, the superimposed electric field is focused onto the active surface of imaging detector 194 by focusing optics 197F. Imaging detector 194 generates a spatially resolved image of the intensity of the interference pattern generated by the superimposed electric field 192, |Eₘ+Eₙ|² 196.

Similarly, beam splitter 188 effectively superimposes a portion of basis electric field, Eₙ, with a portion of basis electric field Eₘ. The portion of the electric field, Eₙ, transmitted through beam splitter 188 propagates to beam dump 190. As depicted in FIG. 9, the portion of electric field, Eₙ, superimposed with the portion of Eₘ, by beam splitter 188 propagates through phase delay element 187. Phase delay element 187 introduces 90 degrees of phase delay across the field of the portion of electric field, Eₙ, superimposed with the portion of Eₘ, by beam splitter 188. In some embodiments, phase delay element 187 includes a dielectric material having a thickness and refractive index that changes the optical path length by one quarter wavelength. In other embodiments phase delay element 187 is implemented as an optical delay line, a set of mirrors that lengthens the propagation distance by a quarter wavelength, one or more optical elements having metasurfaces that introduce phase delay by optical resonance, etc.

The superimposed electric field includes electric field, Eₘ, superimposed with electric field, Eₙ, out of phase by ninety degrees. Furthermore, the superimposed electric field is focused onto the active surface of imaging detector 193 by focusing optics 197E. Imaging detector 193 generates a spatially resolved image of the intensity of the interference pattern generated by the superimposed electric field 191, |Eₘ+iEₙ|² 195.

In some embodiments, focusing optics 197A-F includes a tube lens. In some other embodiments, focusing optics 197A-D includes a set of one or more optics having focusing power.

The collection optics of an ellipsometric imaging system may include any type and arrangement of optical filter(s), waveplate(s), analyzing component(s), field stop(s), pupil stop(s), etc., known in the art of ellipsometry. In general, the collection optics includes multiple waveplates, beam splitters, reflective elements, and optical elements having focusing power. In some embodiments, one or more collection optical elements include image filter elements that limit the range of wavelengths of light directed to the imaging detectors. The image filter elements may be bandpass filters and/or edge filters and/or notch filters.

In some embodiments, the collection optics include one or more Soleil waveplates, which employ an adjustable mechanical displacement to adjust retardance. In some embodiments, Soleil waveplates are manufactured from materials compatible with all wavelengths of interest for optical inspection, e.g., all wavelengths ranging from deep ultraviolet to infrared. In some embodiments, the collection optics include one or more liquid crystal based waveplates, having retardance that adjustable in response to an electrical signal.

In some embodiments, the optical transformation modules of a basis electric field generation module are located at or near a pupil of the collection optics of an ellipsometric imaging system. The focusing lens elements of a basis image generation module perform a Fourier transformation of the basis fields. The Fourier transformed field images are recorded at the detectors. Thus, the basis fields are recorded at an image plane at the detectors.

In this manner, the intensity patterns of the detected images are indicative of the intensity of each basis electric field and the intensity of phase interference between each distinct combination of basis electric fields at each location at the wafer under inspection. The intensity patterns are different for defects of interest and regular, patterned structures. In these embodiments, each detector resolves the collected light into discrete locations on the active surface of each detector.

In some embodiments, the retardation of one or more waveplates of basis electric field generation module 140, the clocking angle of one or more waveplates of basis electric field generation module 140, the clocking angle of one or more polarizers of basis electric field generation module 140, or any combination thereof, are adjustable parameters for different imaging intervals or inspection recipes.

In the embodiment depicted in FIG. 1, command signal 151 is communicated to basis electric field generation module 140. In some embodiments, basis electric field generation module includes an actuator subsystem (not shown) configured to change the clocking angle of each waveplate, polarizer, or both, in accordance with command signal 151 communicated from computing system 130. In some embodiments, the actuator subsystem includes a rotary stage capable of rotating an optical element about an axis aligned with the direction of propagation of collected light through the optical element. In some embodiments, the actuator subsystem includes an electrical voltage source capable of changing an optical state of the optical element to effectively change the clocking angle of the optical element.

Similarly, command signal 155 is communicated to basis electric field generation module 140. In some embodiments, basis electric field generation module includes an actuator subsystem (not shown) configured to change the retardance of each waveplate in accordance with command signal 155 communicated from computing system 130. In some embodiments, a waveplate includes an actuator subsystem (not shown) configured to change the wedge angle of the waveplate, which, in turn, changes the retardance of the waveplate in accordance with command signal 155 communicated from computing system 130. In some other embodiments, a waveplate includes a controlled voltage source that applies electrical voltage to a liquid crystal material (not shown), which, in turn, changes the retardance of the waveplate in accordance with command signal 155 communicated from computing system 130.

In the embodiment depicted in FIG. 1, command signal 154 is communicated to basis image generation module 160. In some embodiments, basis image generation module includes an actuator subsystem (not shown) configured to selectively route each distinct pair of basis electric fields to a pair of imaging detectors and an interferometric detector module to generate a set of basis images sequentially in accordance with command signal 154 communicated from computing system 130. In some embodiments, the actuator subsystem includes one or more motion stages capable of moving one or more beam routing elements, i.e., beam splitters, mirror, etc. In some embodiments, the actuator subsystem includes an electrical voltage source capable of changing an optical state of the optical element, e.g., a beam splitter, to effectively change the optical path in basis image generation module 160.

As depicted in FIG. 4, ellipsometry imaging system 100 includes multiple detectors having a planar, two-dimensional surface sensitive to incident light. The detectors are selected for signal to noise ratio performance and fast read-out. The detectors detect the amount of light imaged onto an active, photosensitive surface and generate output signals 161 indicative of the detected light.

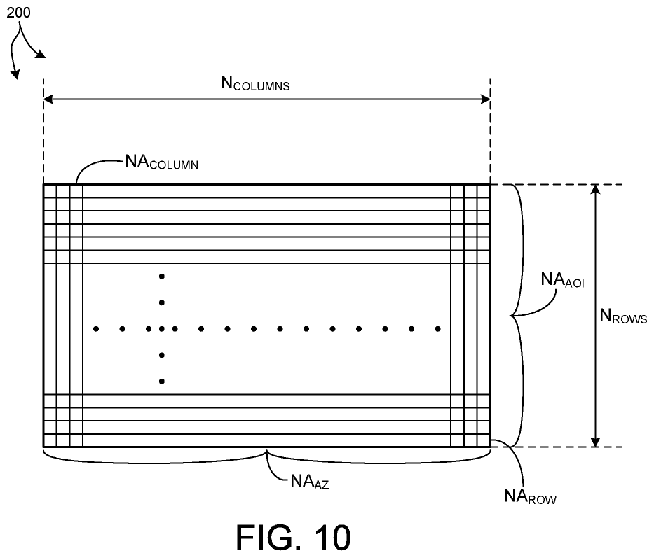

FIG. 10 is a simplified diagram illustrative of a surface of a detector 200. In some embodiments, detectors 162A-D and interferometric detectors 181A-F depicted in FIG. 4 are instances of detector 200 depicted in FIG. 10. The pixels of detector 200 are arranged in a two dimensional array extending in the horizontal and vertical directions relative to the drawing page. Detector 200 includes a number of columns, NCOLUMNS, and a number of rows, NRows. In some embodiments, detector 200 includes 1,000-5,000 columns and 100-200, or more, rows. As illustrated in FIG. 10, collected light is dispersed across detector 200 in the horizontal direction, from the smallest resolved azimuth angle to the largest resolved azimuth angle. In addition, the collected light is dispersed across the detector according to angle of incidence in the vertical direction. The full collection NA in the AOI direction (NA_{AOI}) spans the detector surface in the vertical direction, and the full collection NA in the Azimuth direction (NA_{AZ}) spans the detector surface in the horizontal direction.

As illustrated in FIG. 4, the detectors of basis image generation module 160 generate sixteen images indicative of the intensity of all combinations of the basis set of electric fields {E₀, E₁, E₂, E₃}. Thus, the basis set of images constitutes the intensity at a detector produced by an arbitrary Jones pupil in the imaging path of an ellipsometric imaging system.

As illustrated by FIGS. 4-9, the optical configurations of the basis electric field generation module 140 and the basis image generation module 160 employ static optical components, e.g., waveplates and polarizers that do not move or change optical configuration during an image acquisition interval of a wafer inspection application. In the embodiments, depicted in FIGS. 4-9, the sixteen images of the basis set employed to synthetically generate an ellipsometry image are detected simultaneously. In these embodiments, the optical components of the ellipsometry system do not move or change optical configuration during the image acquisition interval involved in the generation of the synthetic ellipsometry image.

In some other embodiments, the basis electric field generation module 140, the basis image generation module 160, or both, employ static optical components, e.g., waveplates and polarizers that do not undergo movement or changes of optical configuration during an image acquisition interval of a sequence of image acquisition intervals of a wafer inspection application. However, in some of these embodiments, one or more optical components move or change optical configuration between image acquisition intervals.

For example, in some embodiments, a basis electric field generation module includes two electric field transformation modules that simultaneously generate two different transformed electrical fields in one image acquisition interval of a sequence of image acquisition intervals. The two electric field transformation modules include optical elements that are optically reconfigurable. The optical configuration of one or both of the electric field transformation modules is changed between image acquisition intervals, e.g., by rotation of one or more optical elements, an electrically induced change in optical state, etc. At a subsequent image acquisition interval, a different combination of transformed electric fields is generated by the two electric field transformation modules. In this manner, a basis electric field generation module sequentially generates different pairs of the basis set of electric fields, e.g., {E₀, E₁, E₂, E₃}. Furthermore, in these embodiments, a basis image generation module includes four imaging channels. Two imaging channels generate spatially resolved images of the intensity of the each of the pair of electric fields generated by the basis electric field generation module, and two imaging channels generate and detect the intensity of the interference pattern generated by the superposition of each pair of the basis set of electric fields in phase, and out of phase by ninety degrees, respectively. In this manner, a sequence of four image acquisition intervals is implemented to generate the sixteen basis images employed to synthetically generate an ellipsometric image of the wafer under inspection.

In a further aspect, the incoherent sum of each distinct pair of basis electric fields is subtracted from the corresponding detected images of the intensity of the interference pattern generated by the superposition of the pair of electric fields. The resulting images express the complex valued interference of each distinct pair of electric fields.

As depicted in FIG. 9, an interferometric detection module 181 detects an image of the intensity of the interference pattern generated by the superposition of the pair of electric fields, Eₘ and Eₙ, ninety degrees out of phase, |Eₘ+iEₙ|², and an image of the intensity of the interference pattern generated by the superposition of the pair of electric fields, Eₘ and Eₙ, in phase, |Eₘ+Eₙ|². In addition, basis image generation module 160 generates an image of the intensity of each of the basis electric fields, e.g., Eₘ|² and |Eₙ|².

As illustrated by Equations (3) and (4), images of the complex valued interference of a distinct pair of electric fields,

$$2 Real ( {E}_{m}^{*} \cdot {E}_{n} ) = {\vert {E}_{m} + {E}_{n} \vert}^{2} - {\vert {E}_{m} \vert}^{2} - {\vert {E}_{n} \vert}^{2} \qquad ( 3 )$$

$$2 Imag ( {E}_{m}^{*} \cdot {E}_{n} ) = {\vert {E}_{m} + {iE}_{n} \vert}^{2} - {\vert {E}_{m} \vert}^{2} - {\vert {E}_{n} \vert}^{2} \qquad ( 4 )$$

are determined by subtracting the sum of the images of intensity of the pair of electric fields from the image of the intensity of the interference pattern generated by the superposition of the pair of electric fields, both in phase and out of phase by ninety degrees.

$$2 Real ( {E}_{m}^{*} \cdot {E}_{n} ) and 2 Imag ( {E}_{m}^{*} \cdot {E}_{n} )$$

The image of the real part of the superposition of a pair of electric fields,

$$2 Real ( {E}_{m}^{*} \cdot {E}_{n} ) ,$$

component of the total field that is in phase with a reference field. The imaginary part of the superposition of the pair of electric fields,

$$2 Imag ( {E}_{m}^{*} \cdot {E}_{n} ) ,$$

is the component of the total field that is shifted by ninety degrees relative to the reference field. In one example, the reference field is one of the pair of the component electric fields.

In some embodiments, computing system 130 is configured to compute the images of the complex valued interference of each distinct pair of electric fields,

$$2 Real ( {E}_{m}^{*} \cdot {E}_{n} ) and 2 Imag ( {E}_{m}^{*} \cdot {E}_{n} ) .$$

In some other embodiments, a CMOS based detector is configured to compute the images of the complex valued interference of each distinct pair of electric fields,

$$2 Real ( {E}_{m}^{*} \cdot {E}_{n} ) and 2 Imag ( {E}_{m}^{*} \cdot {E}_{n} ) .$$

In this manner, ellipsometric imaging system 100 is configured to measure a set of images characterizing the intensity of the basis set of electric fields,

$${E}_{m}^{*} ( r ) \cdot {E}_{m} ( r )$$

and a set of complex-valued images,

$${E}_{m}^{*} ( r ) \cdot {E}_{n} ( r ) ,$$

characterizing the interference of each distinct pair of the basis set of electric fields.

In a further aspect, a synthetic ellipsometric inspection image, I, is generated as a linear combination of the images of the basis set of electric fields and the complex-valued images characterizing the interference of each distinct pair of the basis set of electric fields in accordance with Equation (5), where jm and jn are optimized values of Jones coefficients associated with a particular inspection recipe.

$$I = {\sum }_{m = 0}^{3} {\sum }_{n = 0}^{3} {j}_{m}^{*} {j}_{n} {E}_{m}^{*} \cdot {E}_{n} \qquad ( 5 )$$

As illustrated in Equation (5), the set of 16 images,

$${E}_{m}^{*} \cdot {E}_{n} ,$$

are weighted by the optimized values of Jones coefficients. Thus, an arbitrary ellipsometry is implemented based on the selection of digitally implemented values of the Jones coefficients. In the embodiment depicted in FIG. 1, computing system 130 generates a synthetic ellipsometric image 153 in accordance with Equation (5). The synthetic ellipsometric image 153 is stored in a memory, e.g., memory 135, for further defect analysis.

This contrasts with the traditional approach which requires a physical implementation of the values of the Jones coefficients. Implementation of arbitrary values of Jones coefficients for ellipsometric imaging significantly enhances sensitivity for certain defects and layers. Furthermore, the perfect repeatability of the values of the Jones coefficients over many measurement intervals improves the accuracy of defect identification.

The implementation of a set of four different static optical configurations dramatically improves ellipsometer system reliability and repeatability compared to traditional imaging ellipsometry implementations. Because the basis set of four different static optical configurations is static, the electric fields generated by each of the basis set of optical configurations are highly repeatable. Furthermore, the Jones coefficients associated with a particular inspection recipe are repeatable to the numerical precision of the values stored in computer memory. Thus, the ellipsometric images determined based on the generated electric fields and the Jones coefficients are highly repeatable.

In a further aspect, a set of values of Jones coefficients defining the mapping of the set of basis images to a synthetic ellipsometric inspection image for a particular inspection application is determined by an optimization of the values of the Jones coefficients over a Design Of Experiments (DOE) data set.

In some examples, one or more DOE wafers having defects of interest at known locations are measured by an ellipsometric imaging system as described herein. A set of basis images is measured over the one or more DOE wafers. An optimization is performed to calculate the values of the Jones coefficients that generate synthetic ellipsometric images that when processed by a defect detection algorithm, identify the known defects of interest with a minimum of nuisance defects, i.e., images with optimal SNR. In this manner, an ellisometric imaging based inspection tool as described herein is able to initiate inspection operations based on an inspection recipe determined with one set of measured basis images.

A search through the space of values of the Jones coefficients can be implemented by computing system 130, or an off-line computing system, with high precision and reduced time, compared to having to explore the space of possible values of the Jones coefficients optically. Performing the search through the space of values of the Jones coefficients on an off-line computing system enables the inspection tool to continue performing inspection of other wafers while the inspection recipe for a new inspection application is processed.

In a further aspect, values of the Jones coefficients are optimized for different regions of the wafer, different structures on the wafer, or both. In this manner, the values of the Jones coefficients defining the ellipsometry vary as a function of inspection location on a wafer, physical characteristics of the structure under inspection, or both. The ability to vary the value of the Jones coefficients over different regions of the wafer enables optimal signal-nuisance separation for wafers exhibiting significant within-wafer variation of film thicknesses, pattern geometry, etc.

In some embodiments, one or more of the optical elements described herein, e.g., lens elements, beam-splitters, waveplates, analyzers, etc. are manufactured as small form-factor meta-surfaces. This enables a space efficient realization of the sixteen imaging channels.

In the embodiment depicted in FIG. 1, the quarter wave plate is not located in the illumination path. In these embodiments, illumination light 125 is linearly polarized as dictated by polarizing element 113. In some embodiments, the illumination polarization is linear and set in the 45° direction. In some other embodiments, a quarter wave plate is located in the illumination path after polarizing component 113. In these embodiments, illumination light 125 is circularly polarized.

In a further aspect, ellipsometric imaging system 100 also includes computing system 130 configured to receive detected images, identify one or more defects of interest on the imaged specimen over the imaged area based on the intensity values of the detected image, and determine a map of defect locations. In some embodiments, computing system 130 receives a synthetic ellipsometric image 153 and determines a location of one or more defects on specimen 101. Moreover, computing system 130 communicates signals 156 indicative of the determined defect locations to memory 135. Memory 135 stores the defect locations for further analysis, reporting, etc.

In some embodiments, computing system 130 identifies one or more defects of interest on the imaged specimen over the imaged area based on a comparison of each intensity value and a predetermined threshold value. In one example, each pixel having a value below a predetermined threshold value is considered a potential defect. In some examples, the intensity values of a small group of pixels, e.g., a small area of fixed size, are averaged and if the average value is below a predetermined threshold value, a potential defect is identified in the center of the evaluated area. In some examples, gradient information is evaluated at each pixel location, e.g., difference in pixel intensity between adjacent pixels, to identify potential defects. In general, any suitable defect identification scheme is contemplated within the scope of this patent document.

In another further aspect, computing system 130 identifies one or more defects of interest on the imaged specimen over the imaged area based on a difference image. The difference image is a pixel by pixel difference between the detected image and a defect-free reference image. In this manner, signal contrast is enhanced.

In some examples, a defect-free, reference image is generated by averaging the pixel intensities associated with a large number of images each collected from different instances of a specimen. In these examples, the presence of a defect at a particular pixel location is relatively rare. In other words, if a defect is found at a particular location on one specimen, it is likely that the defect will not appear at the same location for many other instances of the same nominal specimen. Thus, by averaging the pixel intensities across many instances of the same nominal specimen, the contribution of a defect found at a particular location is vanishingly small. Thus, the averaged image is effectively defect-free.

In the embodiment depicted in FIG. 1, computing system 130 is configured to receive signals 161 indicative of the basis images detected by basis image generation module 160. Computing system 130 is further configured to determine control signals 152 that are communicated to illumination source 110. Illumination source 110 receives control signals 152 and adjusts the illumination power, spectral range, etc. to achieve the desired illumination properties.

In general, any of the illumination and collection optics described herein may be a lens, a compound lens, or any appropriate lens known in the art. Alternatively, any of the illumination and collection optics described herein may be a reflective or partially reflective optical component, such as a mirror.

In some examples, ellipsometric imaging system 100 includes detectors such as lead sulfide (PbS), lead selenide (PbSe), indium antimonide (InSb), indium arsenide (InAs), mercury cadmium telluride (HgCdTe), indium gallium arsenide (InGaAs), x-InGaAs, pyroelectric, and bolometric detectors. Pyroelectric and bolometric detectors are not quantum detectors. Thus, these detectors may accept high light levels without saturation, and thus reduce noise sensitivity.

In some embodiments, the detector subsystem is shot noise limited, rather than dark noise limited. In these examples, it is preferred to perform measurements at high light levels to reduce measurement system noise.

In some embodiments, one or more of the detectors are cooled to temperatures of −20 °C, 210°K, 77°K, or other low temperature to reduce measurement noise. In general, any suitable cooling element may be employed to maintain the temperature of a detector at a constant temperature during operation. By way of non-limiting example, any of a multi stage Peltier cooler, rotating disc cooler, Stirling cycle cooler, N2 cooler, He cooler, etc. may be contemplated within the scope of this patent document.

Each imaging detector generally functions to convert the scattered light into an electrical signal, and therefore, may include substantially any photodetector known in the art. However, a particular detector may be selected for use within one or more embodiments of the invention based on desired performance characteristics of the detector, the type of specimen to be inspected, and the configuration of the illumination. For example, if the amount of light available for inspection is relatively low, an efficiency enhancing detector such as a time delay integration (TDI) camera may increase the signal-to-noise ratio and throughput of the system. However, other detectors such as charge-coupled device (CCD) cameras, photodiode arrays, phototube and photomultiplier tube (PMTs) arrays may be used, depending on the amount of light available for inspection and the type of inspection being performed. The term “imaging detector” is used herein to describe a detector having a sensing area, or possibly several sensing areas (e.g., a detector array or multi-anode PMT). Regardless of number, the sensing areas of an imaging detector generate image signals independent from any other imaging detector.

Ellipsometric imaging system 100 also includes various electronic components (not shown) needed for processing the scattered signals detected by the imaging detectors. For example, ellipsometric imaging system 100 may include amplifier circuitry to receive output signals from the detectors, and to amplify those output signals by a predetermined amount and an analog-to-digital converter (ADC) to convert the amplified signals into a digital format suitable for use within computing system 130.

In general, computing system 130 is configured to detect features, defects, or light scattering properties of the wafer using the detected images. The detected images are generated based on the basis set of images. Computing system 130 may be configured to use any appropriate defect detection algorithm or method known in the art. For example, the computing system 130 may use a die-to-database comparison or a thresholding algorithm to detect defects on the specimen.

In addition, ellipsometric imaging system 100 may include peripheral devices useful to accept inputs from an operator (e.g., keyboard, mouse, touchscreen, etc.) and display outputs to the operator (e.g., display monitor). Input commands from an operator may be used by computing system 130 to adjust threshold values used to control illumination characteristics, collection characteristics, wafer conditioning characteristics, etc. The resulting characteristics may be graphically presented to an operator on a display monitor.

In the embodiment illustrated in FIG. 1, specimen positioning system 102 moves wafer 101 under a stationary microscope. Specimen positioning system 102 includes a chuck 103, motion controller 104, a X-translation stage 105, and a Y-translation stage (not shown). Specimen 101 is supported on chuck 103. As illustrated in FIG. 1, translation stage 105 translates specimen 101 in the X-direction at a specified velocity, VX, and the Y-translation stage translates specimen 101 in the Y-direction. Motion controller 104 coordinates the movements of specimen 101 by the X and Y translation stages to achieve the desired stepping or scanning motion of specimen 101 within ellipsometric imaging system 100.

As illustrated in FIG. 1, a single primary illumination source 110 supplies the illumination energy for the illumination beam. In some embodiments, illumination source 110 is configured to provide monochrome illumination light, e.g., a monochrome source, a selectable monochrome source, etc. In some of these embodiments, phase delay elements and waveplates are designed to function at the selected wavelength of illumination light. In some embodiments, illumination source 110 may be a broadband source. The broadband light may be separated into different wavelength bands supplied to different illumination optics to generate illumination beams of different wavelength. Similarly, light collected from the wafer surface may be separated into different wavelength bands and directed to different sets of imaging detectors.

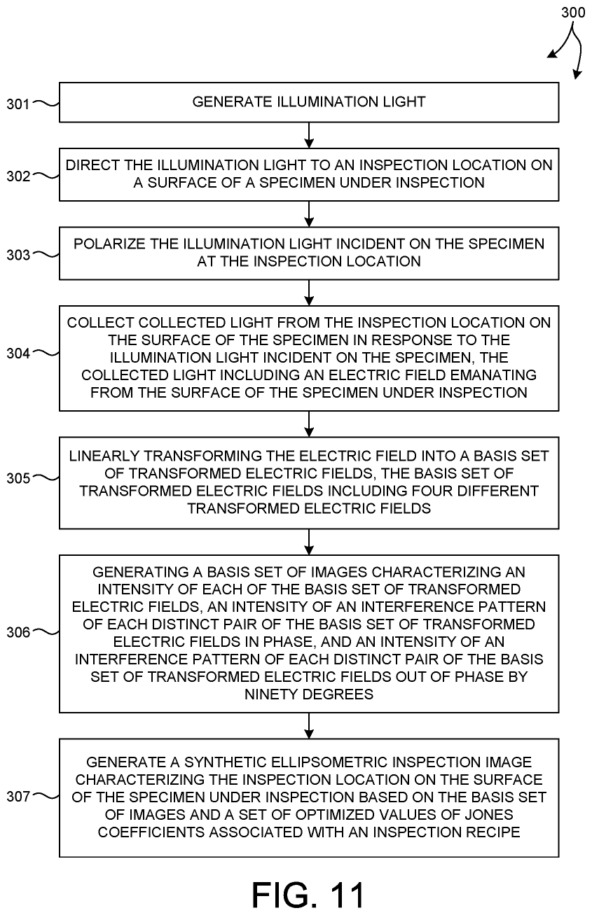

FIG. 11 illustrates a method 300 of performing defect inspection based on ellipsometric images in at least one novel aspect. Method 300 is suitable for implementation by an ellipsometric imaging system such as ellipsometric imaging system 100 illustrated in FIG. 1 of the present invention. In one aspect, it is recognized that data processing blocks of method 300 may be carried out via a pre-programmed algorithm executed by one or more processors of computing system 130, or any other general purpose computing system. It is recognized herein that the particular structural aspects of system 100 do not represent limitations and should be interpreted as illustrative only.

In block 301, an amount of illumination light is generated.

In block 302, the illumination light is directed to an inspection location on a surface of a specimen under inspection.

In block 303, the illumination light incident on the specimen at the inspection location is polarized.

In block 304, collected light is collected from the inspection location on the surface of the specimen in response to the illumination light incident on the specimen. The collected light includes an electric field emanating from the surface of the specimen under inspection.

In block 305, the electric field is linearly transformed into a basis set of transformed electric fields. The basis set of transformed electric fields includes four different transformed electric fields.

In block 306, a basis set of images characterizing an intensity of each of the basis set of transformed electric fields is generated, an intensity of an interference pattern of each distinct pair of the basis set of transformed electric fields in phase, and an intensity of an interference pattern of each distinct pair of the basis set of transformed electric fields out of phase by ninety degrees is generated.

In block 307, a synthetic ellipsometric inspection image is generated. The synthetic ellipsometric inspection image characterizes the inspection location on the surface of the specimen under inspection based on the basis set of images and a set of optimized values of Jones coefficients associated with an inspection recipe.

In a further embodiment, system 100 includes one or more computing systems 130 employed to perform defect inspection of actual device structures based on ellipsometric images collected in accordance with the methods described herein. The one or more computing systems 130 may be communicatively coupled to the detectors. In one aspect, the one or more computing systems 130 are configured to receive image data associated with images of the structure of the specimen under inspection.

It should be recognized that one or more steps described throughout the present disclosure may be carried out by a single computer system 130 or, alternatively, a multiple computer system 130. Moreover, different subsystems of system 100 may include a computer system suitable for carrying out at least a portion of the steps described herein. Therefore, the aforementioned description should not be interpreted as a limitation on the present invention but merely an illustration.

In addition, the computer system 130 may be communicatively coupled to the detectors in any manner known in the art. For example, the one or more computing systems 130 may be coupled to computing systems associated with the detectors. In another example, the detectors may be controlled directly by a single computer system coupled to computer system 130.

The computer system 130 of system 100 may be configured to receive and/or acquire data or information from the subsystems of the system (e.g., detectors and the like) by a transmission medium that may include wireline and/or wireless portions. In this manner, the transmission medium may serve as a data link between the computer system 130 and other subsystems of system 100.

Computer system 130 of system 100 may be configured to receive and/or acquire data or information (e.g., measurement results, modeling inputs, modeling results, reference measurement results, etc.) from other systems by a transmission medium that may include wireline and/or wireless portions. In this manner, the transmission medium may serve as a data link between the computer system 130 and other systems (e.g., memory on-board system 100, external memory, or other external systems). For example, the computing system 130 may be configured to receive measurement data from a storage medium (i.e., memory 132 or an external memory) via a data link. For instance, imaging results obtained using the detector described herein may be stored in a permanent or semi-permanent memory device (e.g., memory 132 or an external memory). In this regard, the imaging results may be imported from on-board memory or from an external memory system. Moreover, the computer system 130 may send data to other systems via a transmission medium. For instance, a map of defect locations 156 determined by computer system 130 may be communicated and stored in an external memory. In this regard, inspection results may be exported to another system.

Computing system 130 may include, but is not limited to, a personal computer system, mainframe computer system, cloud based computing system, workstation, image computer, parallel processor, or any other device known in the art. In general, the term “computing system” may be broadly defined to encompass any device having one or more processors, which execute instructions from a memory medium.

Program instructions 134 implementing methods such as those described herein may be transmitted over a transmission medium such as a wire, cable, or wireless transmission link. For example, as illustrated in FIG. 1, program instructions 134 stored in memory 132 are transmitted to processor 131 over bus 133. Program instructions 134 are stored in a computer readable medium (e.g., memory 132). Exemplary computer-readable media include read-only memory, a random access memory, a magnetic or optical disk, or a magnetic tape.

Various embodiments are described herein for a semiconductor imaging system that may be used for inspecting a specimen within any semiconductor processing tool (e.g., an inspection system or a lithography system). The term “specimen” is used herein to refer to a wafer, a reticle, or any other sample that may be processed (e.g., printed or inspected for defects) by means known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

In yet another aspect, the inspection results described herein can be used to provide active feedback to a process tool (e.g., lithography tool, etch tool, deposition tool, etc.). For example, defect locations determined using the methods described herein can be communicated to a lithography tool to adjust the lithography system to achieve a desired output (e.g., focus and dosage). In a similar way etch parameters (e.g., etch time, diffusivity, etc.) of etch tools or deposition parameters (e.g., time, concentration, etc.) of deposition tools may be adjusted in response to measured defect locations determined using the methods described herein.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO2. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An ellipsometric imaging system comprising:
an illumination source configured to generate illumination light, the illumination light incident at an inspection location on a surface of a specimen under inspection;
an illumination polarizer located in an illumination optical path between the illumination source and the specimen under inspection, wherein the illumination polarizer polarizes the illumination light incident on the specimen;
an optical objective configured to collect collected light from the inspection location on the surface of the specimen in response to the illumination light incident on the specimen over a range of angles of incidence and a range of azimuth angles, the collected light including an electric field emanating from the surface of the specimen under inspection;
a basis electric field generation module including four instances of an optical transformation module, each instance of the optical transformation module having a different optical configuration that linearly transforms the electric field into a transformed electric field, wherein the four instances of the optical transformation module generate a basis set of four transformed electric fields;
a basis image generation module including multiple instances of a detector and at least one instance of an interferometric detector module, the basis image generation module configured to generate a basis set of images characterizing the intensity of each of the basis set of transformed electric fields, an intensity of an interference pattern of each distinct pair of the basis set of four transformed electric fields in phase, and an intensity of an interference pattern of each distinct pair of the basis set of four transformed electric fields out of phase by ninety degrees; and
a computing system configured to:
generate a synthetic ellipsometric image characterizing the inspection location on the surface of the specimen under inspection based on the basis set of images and a set of optimized values of Jones coefficients associated with an inspection recipe.

2. The ellipsometric imaging system of claim 1, the computing system further configured to:
determine the set of optimized values of Jones coefficients based on a set of basis images measured by the ellipsometric imaging system over one or more Design Of Experiments (DOE) wafers.

3. The ellipsometric imaging system of claim 2, wherein different sets of optimized values of Jones coefficients are employed for different regions of a wafer, different structures on a wafer, or both.

4. The ellipsometric imaging system of claim 1, the computing system further configured to:
identify one or more defects of interest on the specimen based on the synthetic ellipsometric image.

5. The ellipsometric imaging system of claim 4, wherein the identifying of the one or more defects of interest involves:
determining a difference image, wherein the difference image is a pixel by pixel difference in intensity values between the synthetic ellipsometric image and a defect-free reference image; and
identifying the one or more defects of interest based on pixel intensity values of the difference image.

6. The ellipsometic imaging system of claim 1, wherein each different optical configuration that linearly transforms the electric field into a transformed electric field is a static optical configuration during an image acquisition interval of the ellipsometric imaging system.

7. The ellipsometric imaging system of claim 1, wherein two or more of the basis set of four transformed electric fields are generated simultaneously.

8. The ellipsometric imaging system of claim 1, wherein the basis set of spatially resolved images includes sixteen images, wherein multiple instances of the detector detect spatially resolved images of the intensity of each of the basis set of transformed electric fields, the one or more instances of the interferometric detector detect spatially resolved images of an intensity of an interference pattern of each distinct pair of the basis set of four transformed electric fields in phase and spatially resolved images of an intensity of an interference pattern of each distinct pair of the basis set of four transformed electric fields out of phase by ninety degrees.

9. The ellipsometric imaging system of claim 1, wherein the generating of the synthetic ellipsometric inspection image involves generating images of a complex valued interference of each distinct pair of the basis set of four electric fields from the basis set of images and determining the synthetic ellipsometric inspection image as a linear combination of the images of the basis set of transformed electric fields and the images of the complex valued interference of each distinct pair of the basis set of four electric fields weighed by the optimized values of Jones coefficients.

10. The ellipsometric imaging system of claim 1, wherein the four instances of the optical transformation module are implemented optically at a pupil plane of the ellipsometric imaging system.

11. The ellipsometric imaging system of claim 1, wherein the optical transformation module includes a first waveplate and a second waveplate.

12. The ellipsometric imaging system of claim 1, wherein the optical transformation module includes a first waveplate, a second waveplate, and a polarizer.

13. The ellipsometric imaging system of claim 1, wherein the detectors of the basis image generation module are time domain integration (TDI) detectors.

14. A method comprising:
generating illumination light;
directing the illumination light to an inspection location on a surface of a specimen under inspection;
polarizing the illumination light incident on the specimen at the inspection location;
collecting collected light from the inspection location on the surface of the specimen in response to the illumination light incident on the specimen, the collected light including an electric field emanating from the surface of the specimen under inspection;
linearly transforming the electric field into a basis set of transformed electric fields, the basis set of transformed electric fields including four different transformed electric fields;
generating a basis set of images characterizing an intensity of each of the basis set of transformed electric fields, an intensity of an interference pattern of each distinct pair of the basis set of transformed electric fields in phase, and an intensity of an interference pattern of each distinct pair of the basis set of transformed electric fields out of phase by ninety degrees; and
generating a synthetic ellipsometric inspection image characterizing the inspection location on the surface of the specimen under inspection based on the basis set of images and a set of optimized values of Jones coefficients associated with an inspection recipe.

15. The method of claim 1, further comprising:
determining the set of optimized values of Jones coefficients based on a set of basis images measured by an ellipsometric imaging system over one or more Design Of Experiments (DOE) wafers.

16. The method of claim 14, further comprising:
identifying one or more defects of interest on the specimen based on the synthetic ellipsometric image.

17. The method of claim 14, wherein two or more of the basis set of transformed electric fields are generated simultaneously.

18. The method of claim 14, further comprising:
generating images of a complex valued interference of each distinct pair of the basis set of transformed electric fields from the basis set of images, wherein the generating of the synthetic ellipsometric inspection image involves a linear combination of the images of the basis set of transformed electric fields and the images of the complex valued interference of each distinct pair of the basis set of transformed electric fields weighed by the optimized values of Jones coefficients.

19. An ellipsometric imaging system comprising:
an illumination source configured to generate illumination light, the illumination light incident at an inspection location on a surface of a specimen under inspection;
an illumination polarizer located in an illumination optical path between the illumination source and the specimen under inspection, wherein the illumination polarizer polarizes the illumination light incident on the specimen;
an optical objective configured to collect collected light from the inspection location on the surface of the specimen in response to the illumination light incident on the specimen over a range of angles of incidence and a range of azimuth angles, the collected light including an electric field emanating from the surface of the specimen under inspection;
a basis electric field generation module including four instances of an optical transformation module, each instance of the optical transformation module having a different optical configuration that linearly transforms the electric field into a transformed electric field, wherein the four instances of the optical transformation module generate a basis set of four transformed electric fields;
a basis image generation module including multiple instances of a detector and at least one instance of an interferometric detector module, the basis image generation module configured to generate a basis set of images characterizing the intensity of each of the basis set of transformed electric fields, an intensity of an interference pattern of each distinct pair of the basis set of four transformed electric fields in phase, and an intensity of an interference pattern of each distinct pair of the basis set of four transformed electric fields out of phase by ninety degrees; and
a non-transitory, computer-readable medium storing instructions that, when executed by one or more processors, causes the one or more processors to:
generate a synthetic ellipsometric inspection image characterizing the inspection location on the surface of the specimen under inspection based on the basis set of images and a set of optimized values of Jones coefficients associated with an inspection recipe.

20. The ellipsometric imaging system of claim 19, the the non-transitory, computer-readable medium further storing instructions that, when executed by the one or more processors, causes the one or more processors to:
determine the set of optimized values of Jones coefficients based on a set of basis images measured by the ellipsometric imaging system over one or more Design Of Experiments (DOE) wafers.
